(19) United States
(12) Patent Application Publication
(10) Pub. No.: US 2026/0060870 A1
(43) Pub. Date: Mar. 5, 2026

(54) SPINAL DECOMPRESSION SYSTEM AND METHOD

(71) Applicant: Stella Row, LLC, Las Vegas, NV (US)

(72) Inventors: Mark H. Bain, Las Vegas, NV (US); Andrea T. Bain, Las Vegas, NV (US)

(21) Appl. No.: 19/316,178

(22) Filed: Sep. 2, 2025

Related U.S. Application Data
(60) Provisional application No. 63/689,069, filed on Aug. 30, 2024.

(51) Int. Cl. A61H 1/02

(52) U.S. Cl. CPC A61H 1/0229; A61H 2201/1621; A61H 2201/1635; A61H 2201/1642; A61H 2201/1652; A61H 2203/0487

(57) ABSTRACT

A spinal decompression system and method, for safely and comfortably applying gravity-based lumbar traction to a user in a vertically suspended position, includes a spinal decompression device having an upright frame and a traction assembly suspended from the frame by a crossed strap. A forward harness support assembly is provided to attach to the traction assembly and hold the traction assembly in a forward condition relative to the upright frame.

### CROSS-REFERENCE TO RELATED APPLICATION

This application claims the benefit of U.S. Provisional Patent Application No. 63/689,069, filed on Aug. 30, 2024, which is incorporated herein by reference in its entirety.

### FIELD OF THE INVENTION

The present invention relates generally to spinal decompression systems and methods, and more particularly, to a traction system and method that stretches the vertebrae, and in particular the lumbar vertebrae, in a compact, vertical/upright, gravity-based, self-operated form to provide therapeutic decompression effects.

### BACKGROUND OF THE INVENTION

Lower back pain is a widespread condition that may result from a variety of causes, including nerve compression associated with degenerative disc disease, herniated discs, arthritic changes of the spine, and other conditions. One recognized approach to addressing such conditions involves spinal decompression, which may alleviate pressure on affected spinal nerves.

A number of non-surgical decompression modalities have been developed. For example, physical therapy and stretching exercises may be beneficial; however, such approaches often require sustained motivation, proper technique, and consistent long-term adherence, which can limit patient compliance and reduce efficacy. Inversion tables are another non-invasive option that may provide measurable decompression benefits; however, inversion therapy typically involves extended setup time, may cause increased cranial pressure, and may produce discomfort associated with the inverted position. In yet another example, clinic-based interventions, such as mechanical spinal decompression systems or chiropractic manipulation, may also provide therapeutic benefit; however, these modalities generally require scheduled appointments, travel to a clinic, and administration by trained professionals, which may reduce accessibility for many individuals, particularly those with demanding work schedules or limited mobility.

Despite the availability of these non-surgical options, significant limitations remain. Such modalities may be time-consuming, costly, and difficult to access, particularly for underserved populations. Moreover, patient adherence to prescribed physical therapy regimens is often low, with dropout rates being substantial. This may be attributed to factors such as discomfort during therapy, slow perception of therapeutic benefit, and lack of user control, particularly when weighed against the associated time and financial costs.

Accordingly, there is need for a solution to at least one of the aforementioned problems. For instance, there is an established need for spinal, and particularly lumbar, stretching devices and methods which are safe, effective, and comfortable, and may be widely accessible.

### SUMMARY OF THE INVENTION

The present invention is directed to a self-operated and gravity-based, spinal decompression system and method for safely and comfortably applying lumbar traction to a user arranged in a vertically suspended position.

In a first implementation of the invention, a spinal decompression system may include:
a traction assembly, comprising:
   a harness defining a harness space configured to receive a portion of a body of a user therethrough, the harness flexibly conformable and securable to said portion of said body by a cinching of said harness against said portion of said body, wherein the harness is open-ended such that the harness only partially encircles said portion of said body, and
   a suspended, strap assembly, attached to and carrying the harness in an elevated relationship with a ground arranged below the harness, the elevated relationship enabling the user to be suspended from the harness, the strap assembly comprising one or more flexible, crossed straps, wherein each crossed strap of the one or more crossed straps comprises respective first and second strap segments having respective first ends attached to said opposite sides of the harness, the respective first and second strap segments extending from said opposite sides of the harness in respective oblique orientations towards one another and in a crossed and disconnected relationship with one another, wherein
   the harness is cinchable onto said portion of the body responsively to said respective first ends of said respecting first and second strap segments of said each cross strap exerting respective oblique forces on said opposite sides of the harness as a result of at least part of a weight of the body of the user being loaded on the harness, said respective oblique forces oriented towards each other.

In a second aspect of the invention, the spinal decompression system may include a standalone frame configured to stably rest on the ground. The harness may be suspended from the frame.

In another implementation of the invention, a method for applying gravity-based lumbar traction to a user in a vertically suspended position may include the steps of:
providing an upright frame including a top support assembly having a rear bar and a front bar;
a traction assembly suspended from said rear and front bars of said frame, said traction assembly including a crossed strap suspended from said rear bar, a U-shaped strap suspended from said front bar and a harness attached to said crossed strap and said U-shaped strap the harness including a center strap segment and first and second sides; and
a forward harness support assembly including a bar assembly attached to said upright frame and a first lower strap extending from said bar assembly and being releasably engageable with said traction assembly;
positioning an upper-abdominal and lower thoracic region of a user in the harness of the traction assembly; and
suspending the user from the traction assembly by the crossed strap cinching the harness to the user's upper-abdominal and lower thoracic region such that the traction assembly vertically supports the user; and
allowing the lumbar region of the user to stretch as a result of gravity.

In a further implementation of the invention, a method of applying spinal decompression may include the steps of:
engaging a lower thoracic and upper abdominal region of a body of a user with a harness that only partially encircles said region;
suspending the harness to support the user in a substantially vertical orientation; and
maintaining a substantially constant normal force on said region of the body by the harness while the harness increases and decreases in diameter in coordination with user respiration.

These and other objects, features, and advantages of the present invention will become more readily apparent from the attached drawings and the detailed description of the preferred embodiments, which follow.

### BRIEF DESCRIPTION OF THE DRAWINGS

The preferred embodiments of the invention will hereinafter be described in conjunction with the appended drawings provided to illustrate and not to limit the invention, where like designations denote like elements, and in which:

FIG. 1 presents a side, rear trimetric view of a spinal decompression device for applying gravity-based lumbar traction to a user in a vertically suspended position in accordance with an exemplary illustrative embodiment of the present invention;

FIG. 2 presents the frame and the traction assembly of FIG. 1, shown separated from one another, wherein a harness of the traction assembly is shown separated from crossed and U-shaped straps of the traction assembly, and further wherein the frame and the harness are shown in side, rear trimetric view while the crossed and U-shaped straps are instead shown in side, front trimetric view;

FIG. 3 presents a partial side elevation view of the spinal decompression device of FIG. 1;

FIG. 4 presents a partial rear elevation view of the spinal decompression device of FIG. 1;

FIG. 5 presents a partial rear elevation view of the spinal decompression device of FIG. 1, illustrating adjustment components of the spinal decompression device, the figure including an enlarged area of detail;

FIG. 6 presents a front, side trimetric view of the spinal decompression device of FIG. 1 shown in a first condition, in which a user has mounted the spinal decompression device and extended their torso into a harness of a traction assembly of the spinal decompression device, the figure further showing an optional auxiliary gravity assist kit of the spinal decompression device;

FIG. 7 presents a partial side elevation view, similar to FIG. 3, with the spinal decompression device shown in a second condition in which the traction assembly is shifted to a forward position and secured in place by forward lower straps of the traction assembly;

FIG. 8 presents a partial rear elevation view of the spinal decompression device of FIG. 7, illustrating an auto-cinching of the harness as the user loads his or her weight on the harness;

FIG. 9 presents a partial side elevation view, similar to FIGS. 3 and 7, demonstrating a transition of the traction assembly from the second condition of FIG. 7 (shown in solid lines) to a third condition (shown in broken lines) by the user stepping off the frame of the spinal decompression device and becoming positioned (as shown in broken lines) in a vertical orientation by gravity;

FIG. 10 presents a top plan view of the traction system and rear bar of the frame of the spinal decompression device in the third condition of FIG. 9;

FIG. 11 presents a side elevation view of a spinal decompression device in accordance with a further embodiment of the present invention, the spinal decompression device shown in the first condition;

FIG. 12 presents a side elevation view of the spinal decompression device and user of FIG. 11, with the spinal decompression device arranged in the second condition;

FIG. 13 presents a side elevation view of the spinal decompression device and user of FIG. 11, with the spinal decompression device arranged in the third condition in which the user is fully suspended from the spinal decompression device and the user's lumbar area is being subjected to a traction force by gravity;

FIG. 14 presents a side elevation view of the spinal decompression device and user, similar to FIG. 13, with the user maintaining one foot on the step assembly to reduce the traction force; and

FIG. 15 presents a side elevation view of the spinal decompression device and user, similar to FIG. 13, with the user maintaining both feet on the step assembly to further reduce the traction force.

Like reference numerals refer to like parts throughout the several views of the drawings.

### DETAILED DESCRIPTION

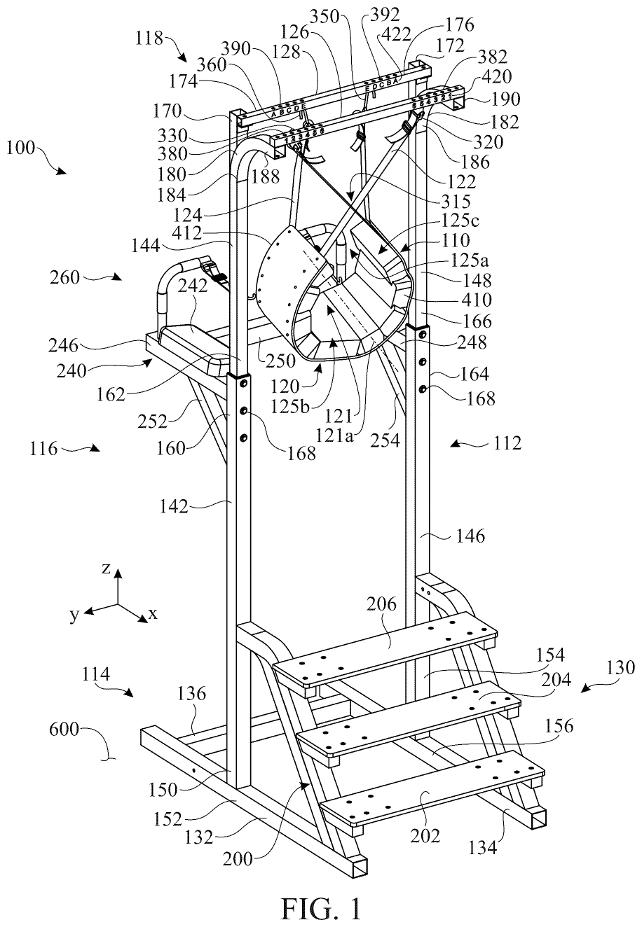

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the invention as oriented in FIG. 1. As used herein, the term comprising can also encompass the terms “consisting essentially of” and “consisting of”. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Shown throughout the figures, the present invention is directed toward a spinal decompression system and method for safely and comfortably applying gravity-based traction to a user's spine in a vertically suspended position. In preferred embodiments, the system comprises a fully self-contained traction device that requires no external supports, weights or electricity to safely and stably support the user during lumbar traction. Furthermore, in preferred embodiments of the invention, the traction system relies on an upper harness to anchor the upper body while gravity provides counter-traction to the lower body mass, isolating forces to the targeted area of the spine. While the present invention is generally directed to spinal decompression, at least some embodiments, such as embodiments described herein, may be particularly advantageously used in lumbar decompression applications.

Referring to FIGS. 1, 2 and 4, and initially with regard to FIG. 1, a spinal decompression device 100 of the traction system, in accordance with an exemplary embodiment of the present invention, configured for applying gravity-based lumbar traction to a user in a vertically suspended position, is illustrated in rear trimetric view. As shown, the spinal decompression device 100 generally includes a traction assembly 110 suspended from a tower or upright frame 112. The frame 112 generally includes a base assembly 114, an upright assembly 116 stably supported by and extending upwardly from the base assembly 114, and a top support assembly 118 carried by the upright assembly 116 in an elevated position with respect to the base assembly 114. The traction assembly 110 is suspended from the top support assembly 118 and securely supported by the frame 112. The frame 112 may be three-dimensionally formed along a front-to-back or longitudinal direction x, a left-to-right or transverse direction y, and a vertical direction z, wherein directions x, y, z are perpendicular to one another and form an orthogonal axis set.

The traction assembly 110 generally includes a harness 120 for comfortably cinching to and vertically supporting the full weight of a user's body as discussed in more detail herein below. The harness 120 defines a harness space 121 configured to receive part of the user's body as described hereinafter; the harness space 121 extends along a central axis or axial direction 121a. The harness 120 is configured to comfortably yet securely engage the user's body; for instance, the harness 120 of the present embodiment is padded or cushioned, as described in greater detail hereinafter. The harness 120 is attached to and suspended from the top support assembly 118 by a strap assembly comprising a rear, crossed strap 122 and a front, non-crossed or U-shaped strap 124.

As further shown, the harness 120 has a front end opening 125a and a rear end opening 125b arranged at opposite ends of the harness 120 along the axial direction 121a of the harness 120. Furthermore, the harness 120 is constructed as an open-ended body configured to only partially wrap around (i.e. not fully encircling) the user's torso; more specifically, as shown, the harness 120 includes a C-shaped or otherwise open perimeter defining a top opening 125c which extends from the front end opening 125a to the rear end opening 125b. The front end opening 125a, the rear end opening 125b, and the top opening 125c are arranged in spatial communication with, and allow access to, the harness space 121.

The crossed strap 122 and the U-shaped strap 124 extend through the harness 120 and are attached to the top support assembly 118 of the frame 112. More specifically, the crossed strap 122 is adjustably suspended from a rear crossbar 126 of the top support assembly 118 while the U-shaped strap 124 is adjustably suspended from a front crossbar 128 of the top support assembly 118. As shown, the rear and front crossbars 126 and 128 of the present embodiment are straight and extend along the transverse direction y, parallel to one another, such as at a same height. A step assembly 130 is provided on the frame 112 to allow a user to climb thereon to gain potential energy and access the traction assembly 110 as will be described in greater detail hereinafter.

The base assembly 114 is configured to stably rest on the ground or floor 600, stabilizing the frame 110. In the non-limiting example shown in the drawings, the base assembly 114 specifically includes a first side channel 132 and a second side channel 134 configured to stably rest on the ground. As shown, the first and second side channels 132 and 134 may be straight and arranged in the longitudinal direction x, parallel to one another. A cross support 136 extends between the first and second side channels 132 and 134, respectively, to secure the first and second side channels 132 and 134 relative to each other. More specifically, the cross support 136 extends between first ends 138 and 140 of the first and second side channels 132 and 134, respectively, and forward of the upright assembly 116. As shown, the cross support 136 may extend perpendicularly to the first and second side channels 132 and 134, along the transverse direction y. In different embodiments of the invention, the base assembly 114 may include alternative or additional bars, reinforcements, or other structural members, without departing from the scope of the present disclosure.

The upright assembly 116 includes a first lower channel 142 extending upwardly at a right angle from the first side channel 132 of the base assembly 114 and a first upper channel 144 adjustably extending upwardly from the first lower channel 142. Similarly, the upright assembly 116 also includes a second lower channel 146 extending upwardly from the second side channel 134 of the base assembly 114 and a second upper channel 148 adjustably extending upwardly from the second lower channel 146. More specifically, a first end 150 of the first lower channel 142 extends upwardly from a center 152 of the first side channel 132 and a first end 154 of the second lower channel 146 extends upwardly from a center 156 of the second side channel 134. As shown, the first lower and upper channels 142 and 144 extend vertically and in alignment with one another, and parallel to the second lower and upper channels 146 and 148, which also extend vertically and in alignment with one another.

A second end 160 of the first lower channel 142 slidably receives a first end 162 of the first upper channel 144 and a second end 164 of the second lower channel 146 slidably receives a first end 166 of the second upper channel 148. The first and second upper channels 144 and 148 are vertically slidable into and out of the first and second lower channels 142 and 146, respectively. Assembly bolts 168 (e.g., two standard bolts and one anti-rattle bolt) are provided to secure the telescoping, first lower and upper channels 142 and 144 together, and to secure the telescoping, second lower and upper channels 146 and 148 together. The assembly bolts 168 may be secured at different relative telescoping positions of the first and second upper channels 144 and 148 with respect to the first and second lower channels 142 and 146, allowing to adjust and lock the telescoping first lower and upper channels 142 and 144 and the telescoping second lower and upper channels 146 and 148 at different height adjustments.

With continued reference to FIG. 1, the top support assembly 118 may be supported by the upright assembly 116 in a height-adjustable, elevated position with respect to the ground or floor 600. More particularly, a second end 170 of the first upper channel 144 and a second end 172 of the second upper channel 148 support opposite, first and second ends 174 and 176 of the front crossbar 128, respectively. In turn, first and second curved channels 180 and 182 extend from the second ends 170 and 172 of the first and second upper channels 144 and 148. More specifically, a first end 184 of the first curved channel 180 extends from the first upper channel 144 and a first end 186 of the second curved channel 182 extends from the second upper channel 148. Second ends 188 and 190 of the first and second curved channels 180 and 182 are attached to opposite, first and second ends 192 and 194 of the rear crossbar 126, respectively.

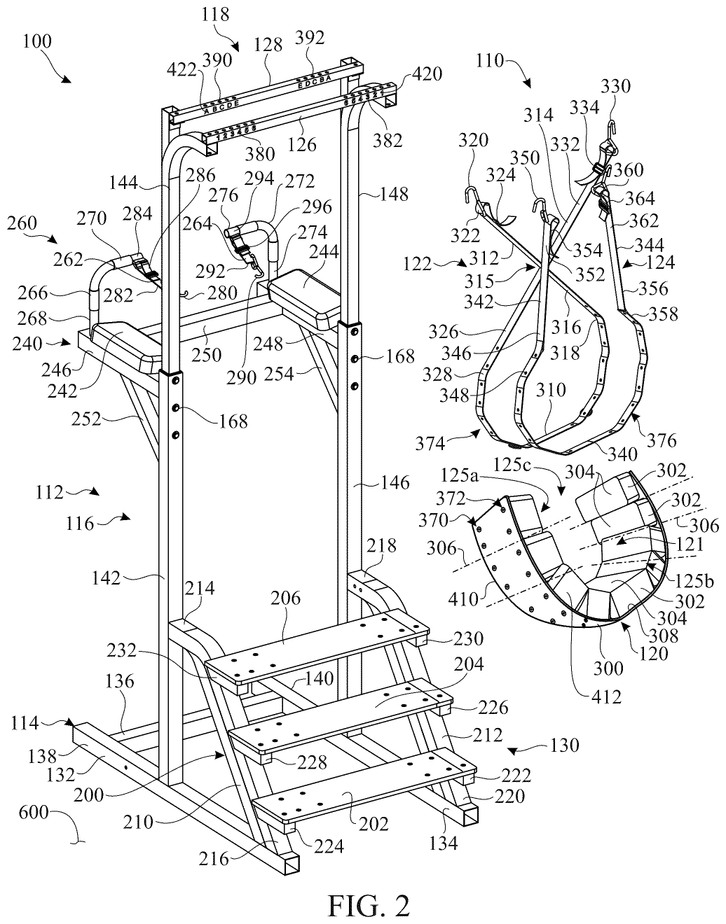

Referring now to FIGS. 1 and 2, the step assembly 130 of the present embodiment includes a step support assembly 200 which supports one or more steps, such as first, second, and third steps 202, 204 and 206. The step support assembly 200 of the present embodiment is affixed to the frame 112. The step support assembly 200 includes a first step support member 210 and a second step support member 212. The first and second step support members 210 and 212 of the present embodiment are constructed similarly to one another and arranged transversely spaced apart with one another, and parallel to one another. The first, second and third steps 202, 204 and 206, respectively, extend across the first and second step support members 210 and 212. A first end 214 of the first step support member 210 is attached to the first lower channel 142 of the frame 112 and a second end 216 of the first step support member 210 is attached to the first side channel 132 of the frame 112. Similarly, a first end 218 of the second step support member 212 is attached to the second lower channel 146 of the frame 112 and a second end 220 of the second step support member 212 is attached to the second side channel 134 of the frame 112. The first and second step support members 210 and 212 may thus reinforce the right-angled structures formed by the first side channel 132 and the first lower channel 142, and the second side channel 134 and second lower channel 144.

The steps 202, 204, 206 are mounted to and supported by the step support assembly 200. More specifically, in the non-limiting example shown in the drawings, the first step 202 is mounted on a first right support block 222 affixed to the second step support member 212 and on a first left support block 224 affixed to the first step support member 210. Similarly, the second step 204 is mounted on a second right support block 226 and a second left support block 228 respectively affixed to the second and first step support members 212 and 210. Likewise, the third step 206 is mounted on a third right support block 230 and a third left support block 232 respectively affixed to the second and first step support members 212 and 210.

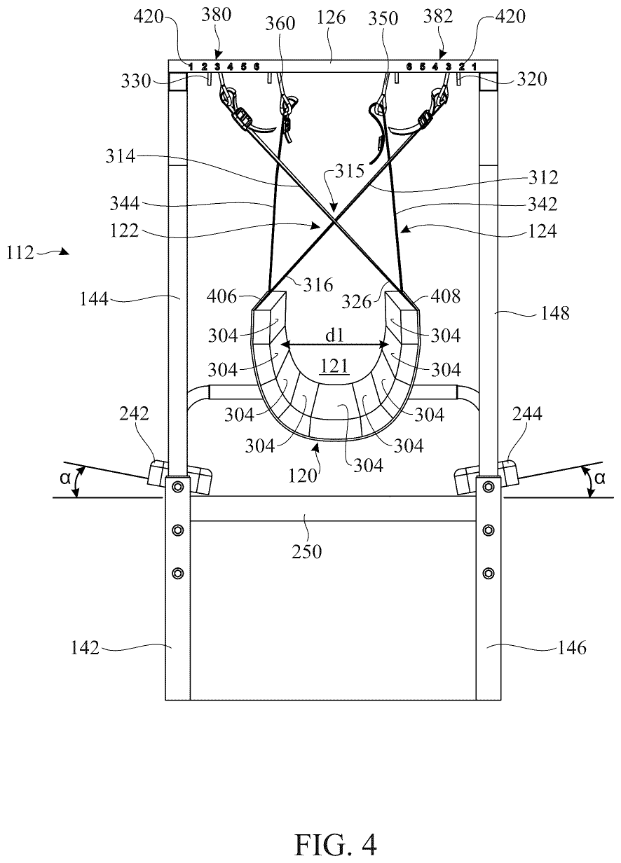

The spinal decompression device 100 further includes an elbow support assembly 240 mounted to the frame 112 including first and second elbow pads 242 and 244 (FIG. 2) mounted on the elbow support assembly 240. The elbow support assembly 240 includes first and second short channels 246 and 248 which extend from the first and second lower channels 142 and 146 of the frame 112. As shown, the first and second short channels 246 and 248 may extend perpendicular to the first and second lower channels 142 and 146 and parallel to the first and second side channels 132 and 134 of the base assembly 114, i.e. along the longitudinal direction x. The first and second short channels 246 and 248 support the first and second elbow pads 242 and 244, respectively. Turning to FIG. 4, in a preferred embodiment, the first and second elbow pads 242 and 244 are oriented slightly inward at an angle of a relative to the crossbar 250 for purposes described hereinafter.

As best shown in FIG. 2, a crossbar 250 extends between the first and second short channels 246 and 248 to stabilize the first and second short channels 246 and 248 relative to the frame 112. As shown, the crossbar 250 may extend transversely, i.e. perpendicular to the first and second short channels 246 and 248, A first brace channel 252 extends at an angle from the first short channel 246 to the first lower channel 142, and a second brace channel 254 extends at an angle from the second short channel 248 to the second lower channel 146. The first and second brace channels 252 and 254 reinforce the first and second short channels 246 and 248 during operation of the spinal decompression device 100, such as by helping to support any weight placed on the first and second elbow pads 242 and 244 and to withstand other forces exerted on the elbow support assembly 240.

As further shown in FIG. 2, the spinal decompression device 100 includes a forward harness support assembly 260 for holding the traction assembly 110 in a forward position relative to the frame 112 to suspend a user from the frame 112 thereby delivering controlled traction to the lumbar area as discussed in detail hereinbelow. The forward harness support assembly 260 includes an adjustable first lower strap 262 and an adjustable second lower strap 264. The first and second lower straps 262 and 264 are releasably engageable with the harness 120 of the traction assembly 110.

The forward harness support assembly 260 of the present embodiment is supported by the frame 112, and, more specifically, is mounted to and carried by the elbow support assembly 240, which, in turn, is affixed to the frame 112. The forward harness support assembly 260 includes a bar assembly 266, 272. The bar assembly 266, 272 of the forward harness support assembly 260 may include a first L-shaped bar 266 having a first end 268 affixed to the first short channel 246 and a second end 270 connected to the first lower strap 262. The bar assembly 266, 272 of the forward harness support assembly 260 may further include a second L-shaped bar 272 having a first end 274 attached to the second short channel 248 and a second end 276 connected to the second lower strap 264. Alternative embodiments are contemplated, however, without departing from the scope of the present disclosure; for instance and without limitation, the first and second L-shaped bars 266 and 272 may extend to one another providing a continuous, transverse crossbar which extends from the first short channel 246 to the second short channel 248 and parallel to the crossbar 250. In some embodiments, at least part of the bar assembly 266, 272 may be covered by a foam or otherwise cushioned layer or sleeve.

The first lower strap 262 has a hook 280 attached to a first end 282 of the first lower strap 262. A second end 284 of the first lower strap 262 is connected to the second end 270 of the L-shaped bar 266. An adjustment buckle 286 is provided in the first lower strap 262 to adjust the length of the first lower strap 262. Similarly, the second lower strap 264 has a first end 292 connected to a hook 290, and a second end 294 connected to the second end 276 of the second L-shaped bar 272. The second lower strap 264 also includes an adjustment buckle 296 to adjust the length of the second lower strap 264. The hooks 280 and 290 are releasably attachable to the harness 120 as discussed in more detail hereinbelow.

With continued reference to FIG. 2, the traction assembly 110 includes the harness 120, the crossed strap 122, and the U-shaped strap 124. It should be noted that the illustration of FIG. 2 shows the straps 122 and 124 of the traction assembly 110 rotated with respect to the frame 112 and the harness 120 such that the pair of straps 122, 124 is shown in front perspective view while the frame 112 and the harness 120 are shown in rear perspective view; furthermore, the harness 120 has been depicted in a slightly forward and downward rotated position to facilitate a better view of the rear opening 125b. The harness 120 is provided to comfortably support the weight of the user and includes a flexible backing panel 300 having a set of moderately compressible pads or cushions 302 attached to an inner side or surface 308 of the backing panel 300; in the non-limiting example shown in the drawings, the set of cushions specifically consists of nine cushions 302. Each cushion 302 may have an inner surface 304 configured to abut against the user's body. The set of cushions 302 may be arranged such that the inner surfaces 304 extend continuously from another, as shown for instance in FIG. 4, contributing to maximize friction against the user's body for purposes hereinafter described. In preferred embodiments, the plurality of inner surfaces 304 extends along the entirety of the inner side of the harness 120 facing the user's body.

Referring again to FIG. 2, in preferred embodiments, the cushions 302 are arranged in consecutive, generally parallel, back-to-back arrangement around the harness space 121. The flexible backing panel 300 constrains each cushion 302 to move as if on a rigid hinge running along a long-edge that each cushion 302 shares with its immediate adjacent cushion 302. More specifically, each cushion 302 is constrained to pivotably move about a pivot axis 306 relative to its immediate adjacent cushion 302, while a pivoting about remaining two axis (perpendicular to axis 306) is blocked by the flexible backing panel 300. This pivoting of adjacent cushions 302 about an intermediate pivot axis 306 produces an articulated chain that is significantly flexible in one axis but rigid in the other two, allowing the harness 120 to optimally conform to a user's body. It should be noted that, in accordance with the above, the present embodiment defines eight pivot axes 306 arranged between the series of nine cushions 302; however, for clarity purposes, the illustration of FIG. 2 shows five pivot axes 306 only.

The crossed strap 122 is flexible and has a center portion or strap segment 310 and first and second relatively straight, extension portions or strap segments 312 and 314, respectively, extending from the center strap segment 310. The first and second strap segments 312 and 314 are obliquely arranged towards one another and are crossed over one another forming an X-shaped arrangement; more particularly, the first and second strap segments 312 and 314 are arranged overlapping with one another at an overlapping area 315 of this X-shaped arrangement allowing the X-shape formed by the straight strap segments 312 and 314 to vary during adjustment and operation of the spinal decompression device 100 as hereinafter described in greater detail. The first strap segment 312 has a first end 316 extending from a first end 318 of the center strap segment 310. A hook 320 is mounted on a second end 322 of the first strap segment 312 and an adjustment buckle 324 is positioned on the first strap segment 310 to adjust the length of the first strap segment 310. Similarly, the second strap segment 314 of the crossed strap 122 has a first end 326 extending from a second end 328 of the center strap segment 310. A hook 330 is mounted on a second end 332 of the second strap segment 314 and an adjustment buckle 334 is positioned on the second strap segment 314 to adjust the length of the second strap segment 314.

The U-shaped strap 124 also has a center portion or strap segment 340 and first and second strap segment 342 and 344. A first end 346 of the first strap segment 342 extends from a first end 348 of the center strap segment 340. A hook 350 is mounted on a second end 352 of the first strap segment 342 and an adjustment buckle 354 is positioned on the first strap segment 342 to adjust the length of the first strap segment 342. The second strap segment 344 of the U-shaped strap 124 has a first end 356 extending from a second end 358 of the center strap segment 340. A hook 360 is positioned on a second end 362 of the second strap segment 344 and an adjustment buckle 364 is positioned on the second strap segment 344 to adjust the length of the second strap segment 344.

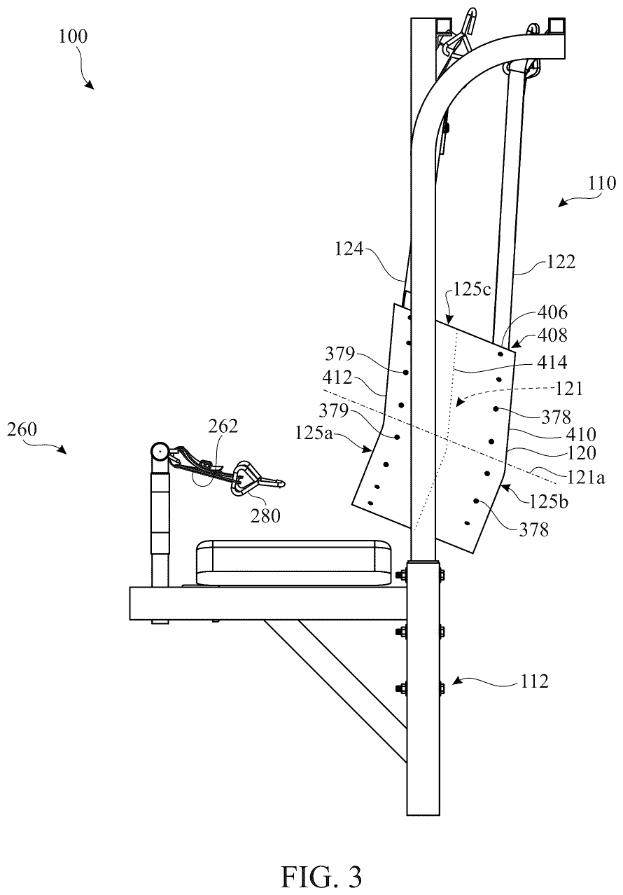

The crossed strap 122 and the U-shaped strap 124 are secured to the harness 120 by positioning the crossed strap 122 and the U-shaped strap 134 between the inner surface 308 of the flexible backing panel 300 of the harness 120 and the cushions 302 of the harness 120. More specifically, the center strap segments 310 and 340 of the crossed strap 122 and the U-shaped strap 124 are secured between the flexible backing panel 300 and the cushions 302 (alternatively, the center strap segments 310 and 340 of the crossed strap 122 and the U-shaped strap 124 may be secured outside the flexible backing panel 300). The flexible backing 300 includes a first line of holes 370 and a second line of holes 372. The center strap segment 310 of the crossed strap 122 has a line of holes 374 which mate up with the first line of holes 370 in the flexible backing panel 300. Similarly, the center strap segment 340 of the U-shaped strap 124 has a line of holes 376 which line up with the second line of holes 372 in the flexible backing panel 300. Fasteners 378 (FIG. 3) extend through the first line of holes 370 in the flexible backing panel 300 of the harness 120 and the line of holes 374 in the center strap segment 310 of the crossed strap 122 to secure the crossed strap 122 in place within the harness 120. Similarly, fasteners 379 (FIG. 3) extend through the second line of holes 372 in the flexible backing panel 300 and the line of holes 376 in the center strap segment 340 of the U-shaped strap 124 to secure the U-shaped strap 124 within the harness 120. The fasteners 378, 379 may consist of bolt and nut fasteners, for instance and without limitation.

As noted above, and best shown in FIG. 1, the crossed strap 122 and the U-shaped strap 124 of the traction assembly 110 are suspended from the rear crossbar 126 and the front crossbar 128 of the frame 112, respectively. The rear crossbar 126 includes a first set of adjustment holes 380 for receipt of hook 330 of the rear cross strap 122 and second set of adjustment holes 382 for receipt of hook 320 of the rear cross strap 122. Similarly, the front crossbar 128 of the frame 112 includes a first set of holes 390 and a second set of holes 392. The first and second sets of adjustment holes 390 and 392 are provided to receive the hooks 360 and 350 of the U-shaped strap 124, respectively.

The crossed strap 122 and the U-shaped strap 124 of the traction assembly 110 may be formed of a synthetic webbing material. The flexible backing panel 300 of the harness 120 of the spinal decompression device 100 may be formed of a flexible, highly-durable plastic sheet material while the cushions 302 of the harness 120 may be formed of a moderately dense, high grip, high friction material, such as, but not limited to, self-contouring memory foam. In some embodiments, each foam cushion 302 may be attached to a respective, rigid base plate such (e.g., made of plywood or hardwood), which in turn may be attached to the flexible backing panel 300, such that each block formed by a foam cushion 302 and corresponding base plate is articulated with respect to the adjacent block(s) by the aforementioned pivot axis 306. In one example, the contact surface 304 of the cushions 302 facing the harness space 121 may include a textured, rubberized vinyl.

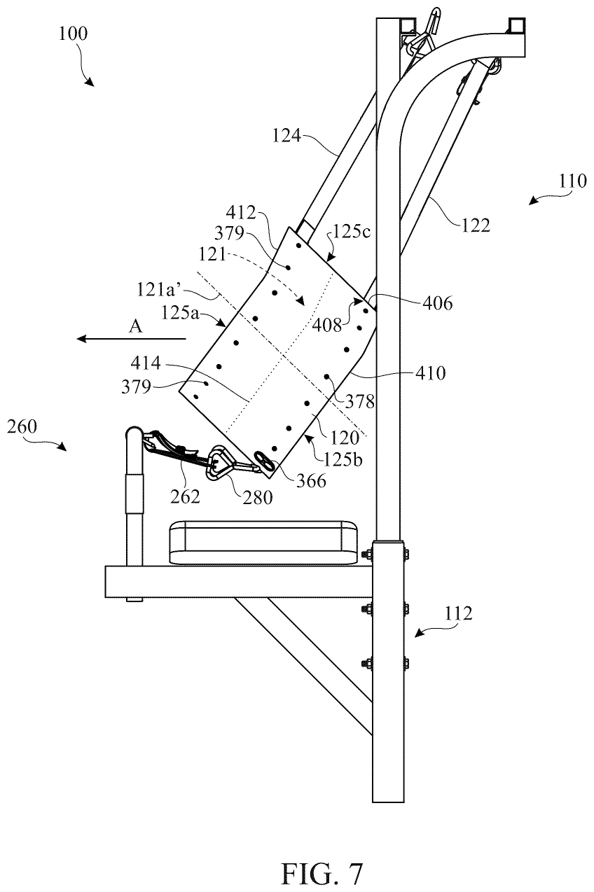

As shown for instance in FIG. 7, the harness 120 may include one or more holes or other attachment devices 366 configured to disconnectably attach to the hooks 280 and 290 of the forward harness support assembly 260. In the non-limiting example, the attachment devices 366 are provided on or otherwise formed in the backing panel 300 of the harness 120.

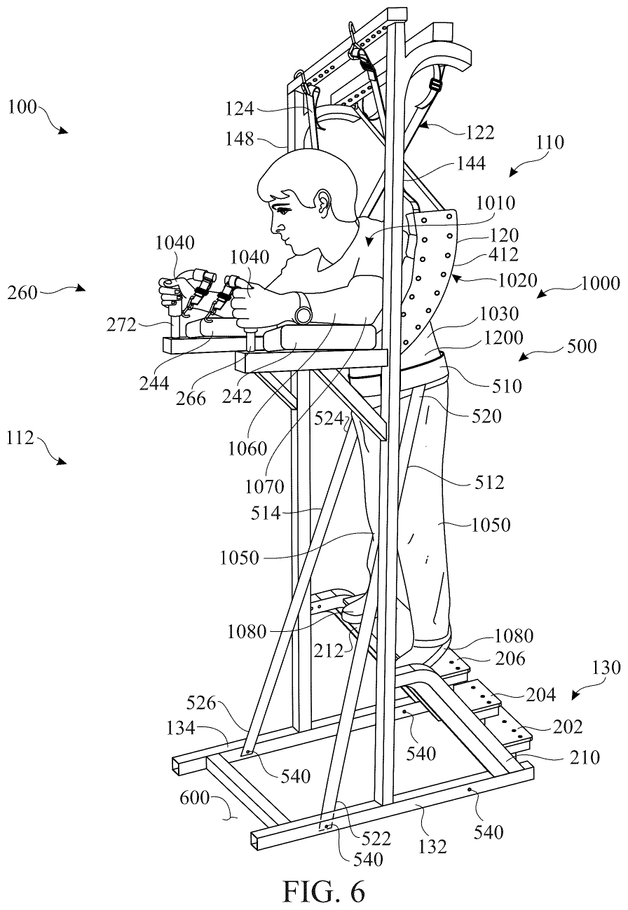

Operation of the disclosed spinal decompression device 100 to apply gravity-based lumbar traction to a user 1000 (FIG. 6) in a vertically suspended position is now described with reference initially to FIGS. 1 and 3. As shown, the frame 112 of the spinal decompression device 100 is initially positioned on the ground or floor 600, as heretofore described, and the harness 120 is suspended from the elevated, top support assembly 118 of the frame 112. Furthermore, the harness 120 is disconnected from the first and second lower straps 262 and 264 (FIG. 2) of the forward harness support assembly 260 and is solely suspended from the top support assembly 118 of the frame 110, as shown. In this initial and unweighted condition of the harness 120, the inner diameter of the harness 120, i.e. the diameter of the harness space 121, is equal to “d1”, as indicated in FIG. 4. As shown in FIG. 3, the harness 120 is obliquely oriented or formed such that the rear opening 125b is slightly lower than the front opening 125a of the harness 120, and such that the central axis 121a is slightly sloped upward. Furthermore, the weight of the harness 120 as such is supported by both the crossed strap 122 and the U-shaped strap 124. Additionally, the U-shaped strap 124 assists in holding the harness 120 at an ergonomic angle or rearward orientation in which the axial direction 121a and the rear opening 125b are sloped rearward and downward facilitating user entry.

Turning to FIG. 6, the user 1000 then mounts the spinal decompression device 100 by climbing the step assembly 130. In climbing the step assembly 130, the user 1000 acquires an amount of potential energy and positions his or her body 1010 in an orientation facing the ergonomically oriented, empty harness 120. The user 1000 may start shifting his or her body 1010 into the harness 120 before reaching the top step 206 or once the user 1000 has climbed to the top step 206; for instance, in the depicted, non-limiting example, the user 1000 is shown standing on the top step 206. To position his or her body 1010 into the harness 120, the user 1000 then passes his or her arms 1060, head and shoulders through the harness 120, the crossed strap 122 (below the overlapping area 315) and the U-shaped strap 124, and extends his or her body 1010 forward, preferably until the rear edge 412 of the harness 120 is within about an inch of the navel thereby positioning a lower portion of the cushioned harness 120 generally below rib 10, with the rest of the harness 120 generally above rib 10, for purposes described hereinafter. The upper-abdominal and lower thoracic region 1030 of the user 1000 becomes positioned in the harness space 121, with the upper torso 120, arms 1060, shoulders, and head arranged forward of the harness 120, and between and forward of the first and second upper channels 144 and 148 of the frame 112, towards the front of the spinal decompression device 100. Arranging the user's upper-abdominal and lower thoracic region 1030 within the harness 120 is facilitated by the upward orientation of the harness 120 and central axis 121a heretofore described, as this upward orientation follows the natural upwards trajectory the lateral thoracic wall at rib 10. If needed, the user 1000 may use his or her hands 1040 to grasp the bar assembly 266, 272 (e.g., the first and second L-shaped bars 266 and 272 in the present embodiment) of the forward harness support assembly 260 to facilitate shifting their body 1010 forward to position the upper-abdominal and lower thoracic region 1030 at the harness 120. The user's arms 1060, including elbows 1070, may rest on the first and second elbow pads 242 and 244 of the elbow support assembly 240. In some embodiments, the inward-sloped, first and second elbow pads 242 and 244 (angle of a indicated in FIG. 4) may provide a greater counteracting force sufficient to oppose a possible natural tendency of user 1000 to steady themselves by outwardly displacing their elbows.

The spinal decompression device 100 and user 1000 are now arranged in a first condition, shown in FIG. 6, in which the user 1000 is still not resting his or her weight on the harness 120 or shifting the harness 120 forward. Thus, the harness 120 remains in, or substantially in, the initial and unweighted condition of FIGS. 1, 3 and 4. More specifically, the harness 120 remains arranged, or substantially arranged, in the orientation shown in FIG. 3, in which the axial direction 121a of the harness space 121 is only slightly sloped rearward and downward, the inner diameter of the harness 120—or diameter of the harness space 121—remaining equal or substantially equal to “d1”, as shown in FIG. 4.

From the first condition of FIG. 6, and turning now to FIG. 7, the user 1000 proceeds to lower their body weight on the harness 120, causing the harness 120 to automatically cinch (as hereinafter described in greater detail) onto the user's upper-abdominal and lower thoracic region 1030 to a first degree. In preferred embodiments, contouring and anchoring of each cushion 302 around the upper abdomen and the lateral thoracic wall 1030 at rib 10, as soon as the user 1000 lowers his or her weight on the harness 120, is facilitated by the user having initially positioned the bottom edge of the harness 120 within about an inch of the navel as heretofore described. Additionally, the user 1000 proceeds to push with their legs and thereby shift their body 1010 forward towards the forward harness support assembly 260, as indicated in FIG. 7 by arrow A, which further assists the user 1000 in loading his or her weight on the harness 120 and thereby auto-cinching the harness 120 to a greater degree. Once advanced forward, the harness 120 may be secured in place, as shown in FIG. 7, by securing the hooks 280 and 290 of the first and second lower straps 262 and 264 (FIG. 2) of the forward harness support assembly 260 to the holes or other attachment devices 366 of the harness 120 as described hereinabove. The spinal decompression device 100 is now arranged in a second condition, in which the harness 120 is shifted forward and secured to the forward harness support assembly 260, and further in which the frame 110, and particularly the elbow support assembly 240 and the forward harness support assembly 260, are loaded with part of the user's weight. In this loaded, second condition, the first and second brace channels 252 and 254 of the elbow support assembly 240 provide a counterforce, which may be particularly advantageous in embodiments in which the bar assembly 266, 272 is more specifically under cantilever load by the first and second lower straps 262 and 264 (for example, in embodiments such as the present embodiment, in which the first and second lower straps 262 and 264 are attached to and apply their load respective free ends of L-shaped bars 266 and 272). Furthermore, as the harness 120 moves from the first condition (FIG. 6) to the second condition (FIG. 7), the axial direction 121a of the harness space 121 moves towards a more vertical orientation, i.e., acquires a greater vertical component (as can be seen by the axial direction rotating clockwise from the first condition shown in side elevation view and denoted by reference numeral 121a in FIG. 3 to the second position shown in side elevation view and denoted by reference numeral 121a′ in FIG. 7). In addition, as the harness 120 moves from the first condition (FIG. 6) to the second condition (FIG. 7), the weight of the harness 120 and the user 1000 is increasingly supported by the crossed strap 122 in comparison to the U-shaped strap 124. More specifically, as the harness 120 swings forward, the U-shaped strap 124 and the crossed strap 122 each rotate about their respective anchor bars-front bar 128 and rear bar 126. Because the rear bar 126 is positioned farther from the instantaneous direction of motion of the harness 120, the rear, crossed strap 122 becomes taut before the front, U-shaped strap 124. Further, due to its X-shaped configuration, the crossed strap 122 shortens in effective span (as viewed in side elevation in FIGS. 3 and 7) as the harness 120 continues to swing forward and upward. This progressive shortening increases tension in the rear, crossed strap 122 and causes the rear, crossed strap 122 to progressively tension while the front, U-shaped strap 124 progressively slackens as the user 1000 transitions from the first condition (FIG. 6) to the second condition (FIG. 7).

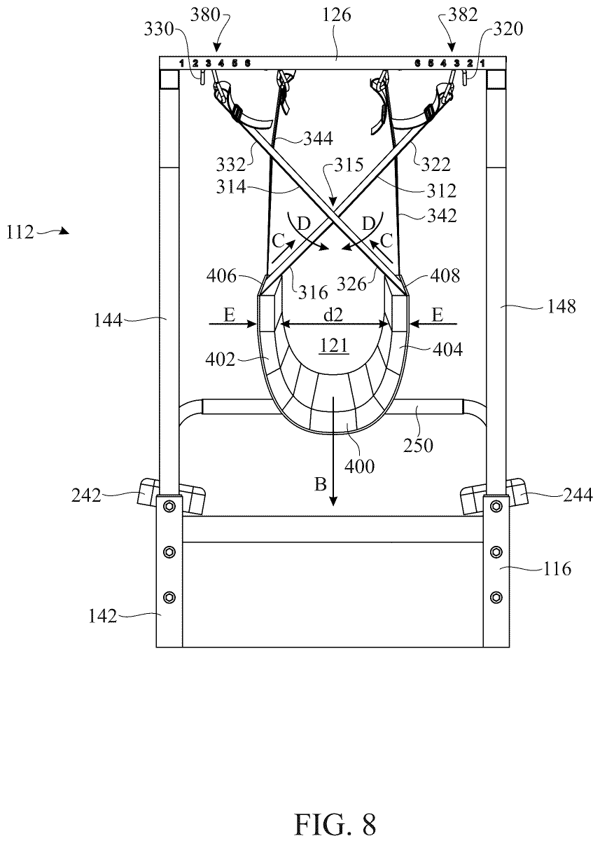

Turning to FIG. 8, the automatic cinching of the harness 120 against the user's body 1010 (which begins as the user exerts his or her weight on the harness 120 from the first condition of FIGS. 1, 3, 4 and 6 and is enhanced by the user shifting the harness 120 forward and securing the harness 120 in the second condition) is now described. As the user's weight is lowered onto the harness 120, and also as the harness 120 is shifted forward, the user's weight is exerted vertically downward on a bottom, center portion 400 of the harness 120 causing the center portion 400 to move downwardly in the direction of arrow B. At least part of this downward pulling force is transmitted to respective attachment points 406 and 408 between the first and second strap segments 312 and 314 of the crossed strap 122 and opposite, first and second sides 402 and 404 of the harness 120, causing the attachment points 406 and 408 to pull on the first ends 316 and 326 of the first and second strap segments 312 and 314 with a force having a substantial vertically downward component. Since the first and second strap segments 312 and 314 are obliquely oriented and movable with respect to the top, rear crossbar 126 (at the respective hook connections with the rear crossbar 126), the generally vertically downward pulling force on the first ends 316 and 326 of the first and second strap segments 312 and 314 causes the first ends 316 and 326 of the tensioned and straight, first and second strap segments 312 and 314 to pull on the attachment points 406 and 408 with oblique forces (arrows C) while the first and second strap segments 312 and 314 rotate about fixed points (the engagement points between the hooks 320 and 330 and the corresponding holes 382 and 380, respectively), as indicated by arrows D, i.e. such that the first ends 316 and 326 of the first and second strap segments 312 and 314, respectively, move closer to one another. In consequence, the attachment points 406 and 408 are pulled towards one another by the first and second strap segments 312 and 314, as indicated by arrows E, which shifts the sides 402 and 404 of the harness 120 towards one another thus cinching the harness 120. As a result of these radially inward forces (arrows E) produced in the harness 120, the inner diameter of decreases from the initial diameter “d1” (FIG. 4) to a gradually smaller diameter “d2”. In gradually decreasing its diameter, the harness 120 increasingly snugly, yet comfortably, fits radially onto the user's body 1010. These radial forces gradually increase as the user 1000 progressively increases the amount of weight exerted on the harness 120, i.e. the downward force (arrow B) exerted on the harness 120. Furthermore, in this particular embodiment of the harness 120, the user's weight (downward force) in combination with the forward movement (arrow A in FIG. 7) cumulatively produce a pivoting effect of the first and second strap segments 312 and 314 about the anchoring hooks 320 and 330 on the upper rear bar 126, respectively, thus increasing the radially inward forces (arrows E). Thus, the effect of pulling the strap attachment points 406 and 408 towards one another results in the harness 120 automatically tightening and contouring around the upper abdomen and lower thoracic region of the user 1000. Furthermore, as the harness 120 is flexible as heretofore, the radial forces (arrows E) at attachment points 406 and 408 are distributed or divided into multiple radially inward forces exerted by the consecutive cushions 302 of the harness 120. This allows generally the entirety of the harness 120 to snugly and comfortably fit onto the user's torso without generating relatively stronger pressure points. In this way, the harness 120 accomplishes an auto-cinch by which the harness 120 is capable of exerting a sufficient normal force against the user's body to produce a friction high enough to counter the force of gravity, which grants the harness 120 sufficient vertical holding power for purposes described hereinafter.

In some embodiments, the spinal decompression system may further include instructions or recommendations for use directed to further promoting friction between the cushions 302 and the user's body 1010. The recommendations may include guidance to avoid outer garments made from low-friction fibers (e.g., slick synthetic athletic wear) and instead to select thin, compliant fabrics such as cotton T-shirts that better conform and maintain frictional engagement. Alternatively or additionally, the recommendations may include instructions to enhance garment compliance—for example, by lightly misting the garment surface with water or using other hydration methods which can improve fiber compliance, skin pliability, and capillary adhesion, thereby increasing the real area of contact and the effective coefficient of friction. The aforementioned recommendations may be provided, for instance and without limitation, on a physical support (e.g., paper) or electronic support (e.g., on a website, software application, or other applicable software interface accessible by the user 1000 on an electronic device, such as, but not limited to, a phone, tablet, or computer).

It should be noted that, at any moment during operation of the spinal decompression device 100, should the user 1000 perceive this auto-cinching effect as being too tight or too loose, the user 1010 may choose to exit the harness 120, make adjustments to the spinal decompression device 100 (discussed hereinafter) in order to balance the normal force (required for effective friction) with desired comfort, and re-enter the harness 120 to repeat the process.

Turning again to the overall method of operation of the spinal decompression device 100, from the second condition of FIG. 7 (in which the harness 120 is secured in a forward and more vertical position within the frame 112 and has auto-cinched to the user's body), the user can proceed to step off of the step assembly 130. In stepping forward and off of the step assembly 130, the user 1000 shifts from the forward-leaning position heretofore described with respect to FIG. 7 to a subsequent position in which the user 1000 is suspended from the harness 120 at his or her upper-abdominal and lower thoracic region 1030, with the user's body 1010 oriented generally vertically upright and the user's feet 1080 unsupported and free, and the harness 120 and thus shifted to a third condition.

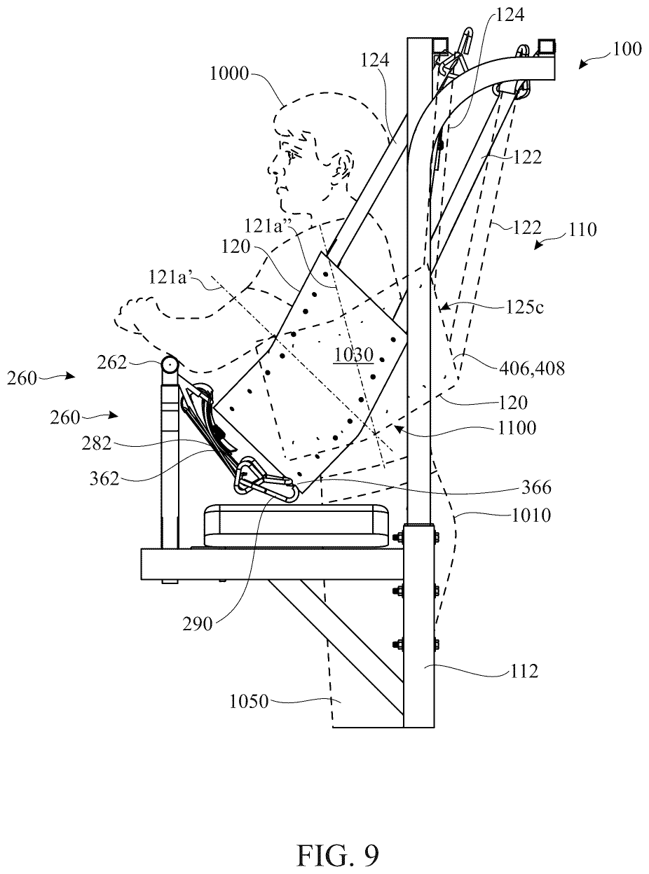

More specifically, turning to FIG. 9, the illustration shows the transition of the harness 120 from the second condition (shown in solid lines and matching the position of FIG. 7) to the third condition (shown in broken lines). In the third condition, the axial direction (indicated with reference numeral 121a″) of the harness 120 (broken lines) has rotated further clockwise about the attachment devices 366 and with respect to the second condition (axial direction 121a′), and is substantially vertical as shown, the user's body 1010 thereby being oriented in a comfortable, vertical position, shown in broken lines. As the harness 120 switches from the second condition (solid lines) to the third condition (broken lines), the attachment devices 366 remain relatively fixed in space while the attachment points 406 and 408 rotate rearward and downward (clockwise around the attachment devices 366), and therefore the attachment points 406 and 408 move even closer to one another due to the aforementioned oblique forces further auto-cinching the crossed strap 122; in this way, gradually rotating the harness 120 rearward and downward (about the pivot points or attachment devices 366) when switching from the second condition to the third condition produces a cumulative or gradually-increasing effect on the auto-cinching of the harness 120 onto the user's body.

In the third condition, the harness 120 (shown in broken lines) supports the user in a generally vertical position (also shown in broken lines). With the user 1000 now arranged in this generally vertical position, the user's upper-abdominal and lower thoracic region 1030 is firmly grasped within—and thus axially held secure with respect to—the harness 120 by the inward radial snug fitting of the harness 120 due to the aforementioned auto-cinching mechanical effect of the crossed strap 122 in the third condition (shown in broken lines), which now supports a significant part of the user's weight (the rest of the user's weight being supported by the front straps 262 and 264).

With the user's body 1010 positioned generally vertical and the user's upper-abdominal and lower thoracic region 1030 axially held secure by the harness 120, and in having both feet unsupported and free, a downward traction force is exerted on the lumbar region which is generally coaxial with the user's spine and roughly equivalent to the wight of the body mass below vertebrae T10, minus any upward unloading due to the harness 120 pulling up on the upper abdominal soft-tissues and lower thoracic region. This traction is facilitated by elevated friction between the harness 120 and the user's body 1010 maintaining the user's upper-abdominal and lower thoracic region 1030 secured in place by the crossed strap 122 (shown in broken lines) imparting inwardly radial forces to the cushions 302 (as heretofore described), which in turn impart radially inward forces on the user's body 1010 to generate shear friction. The radially inward forces may be optimally balanced by the cushions' memory-foam durometer and by the large contact surface area offered by the continuous contact surfaces 304, which lead to increased friction which enables the harness 120 to provide secure and comfortable holding power as it conforms to the body, with only a modest (and therefore comfortable) amount of radial compression exerted onto the user's body.

In preferred embodiments, the harness 120 may be specifically configured such that, in this third configuration, the harness 120 grips the abdominal wall soft tissue exterior and the anterior/side portions of the approximate region near to ribs 7-10, with firmer anchoring beneath the anterior and lateral aspects of rib 10. Above this level, from rib 9 to rib 7, the anchoring effect may gradually taper, while distributed friction across the full vertical span and across all nine cushions 302 contributes to overall stability and holding power.

The spinal decompression device 100 provides the user 1000 a virtually effortless transition through the first and second conditions, and finally into the third condition (gravity-based lumbar traction in a vertically suspended position). During the lumbar decompression while in the third condition, the connection between the harness 120 and the fixed, forward harness support assembly 260 prevents the harness 120 and the suspended user 1000′ from shifting or pivoting downward; additionally, the user's weight is supported by the crossed strap 122 in the third condition (FIG. 9, broken lines) and the first and second lower straps 282, 292 (FIG. 2). In the third condition, the user 1000″ is comfortably secured within the harness 120 and suspended vertically in a free unencumbered space that is forward relative to the upright frame 112. Thus, the disclosed spinal decompression device 100 provides a gravity-based traction levels in an upright suspended posture while comfortably supporting the weight of the user 1000.

The harness 120 is constructed as an open-ended body or C-shape which does not fully encircle the user's upper-abdominal and lower thoracic region 1030, but rather defines the top opening 125c, as heretofore described. Referring to FIG. 9, when the suspended user 1000 breathes, the top opening 125c of the harness 120 (shown in broken lines)—the top opening 125c now arranged at or near the person's back—can vary in size to accommodate for chest expansion and contraction during breathing; specifically, the top opening 125c dilates or gets larger when the user 1000 inhales, and gets smaller when the user 1000 exhales, simultaneously to the harness 120 maintaining enough comfortable radial pressure to maintain the minimally required frictional normal-force against the user's body 1010 in order to keep holding the user 1000 comfortably vertical.

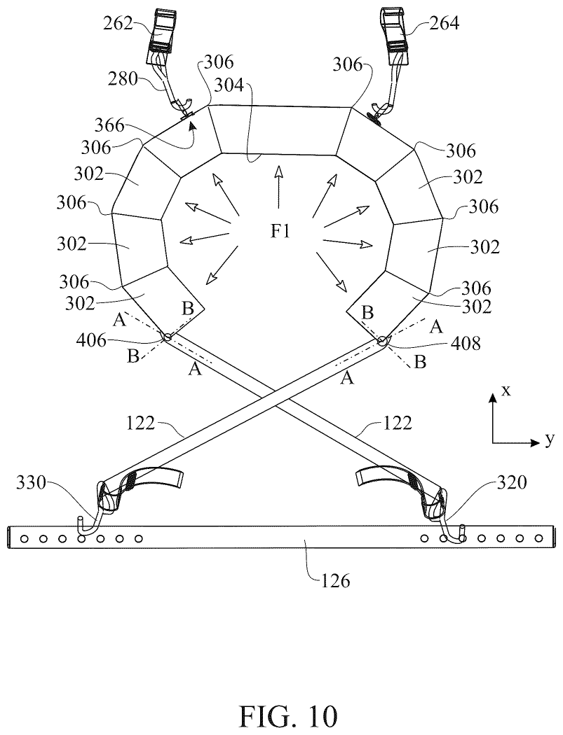

In preferred embodiments, and with reference now to FIG. 10, the harness 120 is configured to maintain a substantially constant normal force against the user's torso during said expansion and contraction. On the left side of upper rear bar 126, the crossed strap 122 is anchored at a fixed point (hook 330) and is in tension all the way to attachment point 408. Similarly, on the right side of the upper rear bar 126, the crossed strap 122 is anchored at a fixed point (hook 320) and is in tension all the way to attachment point 406. The front three cushions (indicated with reference numerals 302a, 302b, 302c) of the harness 120 are locked in all degrees of freedom due to the force of gravity pulling on the body of the user, which consequently pulls the front of harness against attachment points or devices 366, making the first and second lower straps 262 and 264 taut; additionally, as seen in the top plan view, the first and second lower straps 262 and 264 are positioned slightly outboard of the attachment points or devices 366, thereby producing a counterforce to each other and keeping the front of harness 120 locked from side-to-side movement (i.e. movement along the transverse direction y). Furthermore, attachment points 406 and 408 are locked in direction AA due to the oblique forces on crossed the strap 122 in balance with outward radial forces F1 (from the user's body) pushing radially outwards on the inner contact surface 304 of all articulating cushions 302. The attachment points 406 and 408, however, are relatively free to move in the one degree of freedom that they have along line BB (since the oblique left strap 122 can rotate clockwise about fixed point or hook 330, and the oblique right strap 122 can rotate counter-clockwise about the fixed point or hook 320, and both points 406 and 408 are on respective articulating cushions 302 that rotate about a respective axis 306 that is shared with its respective neighboring cushion 302). Thus as the user's chest expands during inhalation, attachment points 406 and 408 are generally free to follow a radially outward direction that follows close to line BB. Thus, in said preferred embodiments, during exhalation the user experiences unrestricted breathing without any change in vertical shear friction, nor any change in comfort, for three reasons. Firstly, at attachment points 406 and 408, the force F1 is practically perpendicular to the oblique tension forces in the crossed strap 122, and it is along this perpendicular path that attachment points 406 and 408 have the most degrees of freedom to move. Secondly, the chest expansion along line BB is small enough to keep attachment points 406 and 408 constantly and practically on this perpendicular line during the entire cycle of expansion/contraction. Thirdly, the cushions 302 have a high amount of contact surface area (area of contact surface 304) for the expanding thoracic cage to push against, during inhalation.

During exhalation, the above process happens in reverse. As the chest wall moves inwards, the attachment point 408 at the end of left crossed strap 122 rotates counterclockwise about the fixed point (hook 330), and attachment point 406 at the end of right crossed strap 122 rotates clockwise about the fixed point (hook 320). Additionally, attachment point 406 rotates counterclockwise about axis 306 that the rearmost left cushion 302 shares with its neighboring cushion 302. Similarly, attachment point 408 rotates clockwise about axis 306 that the rearmost right cushion 302 shares with its neighboring cushion 302. During this process, for the three reasons stated earlier, the user continues to experience unrestricted breathing without any change in vertical shear friction or any change in comfort.

Comfort and unimpeded respiration of the user 1000 throughout the first, second and third conditions may be determined, for instance, by balancing physical properties such as, but not limited to, the self-contouring memory foam properties and high coefficient of friction of the contact surfaces 304 of the cushions 302, and geometrical properties, such as, but not limited to, having the cushions 302 provided with relatively large surface areas 304 and articulately arranged with respect to one another such that the set of cushions 302 can wrap around the lower-thoracic region and upper abdomen of the user 1000 as heretofore described. In addition, the spinal decompression system 100 offers several user-configurable adjustments which further allow to customize the balance between user comfort and the required cinching force; these adjustments are described in detail hereinafter.

To exit the spinal decompression device 100, the process is simply reversed. The user 1000 grasps the first and second L-shaped bars 266 and 272 of the forward harness support assembly 260 and pulls slightly forward to release the hooks 280 and 290, respectively, of the forward harness support assembly 260 from the harness 120 of the traction assembly 110. This may be assisted by pushing off of the step assembly 130 of the frame 112 with the user's legs 1050 to relieve the tension on the first and second lower straps 262 and 264. Once the traction assembly 110 has been released from the forward harness support assembly 260, the user 1000 can move back to again transfer weight to both the crossed strap 122 and the U-shaped strap 124. The user 1000 can then reestablish the legs 1050 on the step assembly 130 (FIG. 6) and exit the harness 120. It should be noted that the arrangement and proximity of the cushions 302, the elastic properties (e.g., durometer) of the memory foam or other compressible material of the cushions 302, and the location of the pivot axes 306 between adjacent cushions 302, together create a “spring hinge” effect which automatically and increasingly uncinches and loosens the harness 120 back to the original maximal diameter “d1” (FIG. 4), as the user 1000 moves progressively from the third condition (FIG. 9, broken lines) to the second condition (FIG. 9, solid lines) and further to the first condition (FIG. 6), facilitating the user exiting the harness 120. Once detached from the harness 120, the user 1000 may dismount the spinal decompression device 100. When the harness 120 is empty and at rest, the “spring hinge” effect maintains the harness space 121 maximally open to receive the next user 1000 at the next session.

With specific reference to FIG. 6, in some embodiments, the disclosed spinal decompression device 100 may further include an auxiliary gravity assist kit 500 to complement the existing gravitation traction force in the third condition, and increase the net lumbar traction. This may improve stretching in the event that the traction force produced by gravity alone is not producing the desired amount of axial stretch to the lumbar region 1000. The gravity assist kit 500 generally includes a waist band or belt 510. The gravity assist kit 500 further includes a pair of side bands 512, 514, namely, a first side band 512 and a second side band 514, extending from the waist belt 510 to a fixed location on the frame 112.

More specifically, the waist belt 510 is provided to be secured around the waist 1200 of the user 1000 and the first and second side bands 512, 514 used to pull down simultaneously on the user's waist 1200. The second side band 514 is positioned diametrically opposite the first side band 512 on the waist belt 510. A first end 520 of the first side band 512 is attached to the waist belt 510 and a second end 522 of the first side band 512 is attached to the frame 112 of the spinal decompression device 100. Similarly, a first end 524 of the second side band 514 is attached to the waist belt 510 and a second end 526 of the second side band 514 is attached to the frame 112. The first ends 520, 524 and the second ends 522, 526 of the first and second side bands 512, 514 may include fasteners (e.g., hooks or pins) configured to preferably disconnectably attach to the waist belt 510 and the frame 112, respectively.

With continued reference to FIG. 6, the second ends 522 and 526 of the first and second side bands 512 and 514 of the gravity assist kit 500 may be releasably attached to the first and second side channels 132 and 134 of the base assembly 114 of the frame 112, respectively. For example, attachment points 540 may be provided on the first and second side channels 132 and 134 of the base assembly 114 to receive or otherwise secure the second ends 522 and 526 of the first and second side bands 512 and 514, respectively. The attachment points 540 may be arranged to position the second ends 522 and 526 of the first and second side bands 512 and 514 in vertical registration with the user's waist in the third condition (FIG. 9); for example, the attachment points 540 shown herein are arranged frontward of the first and second lower channels 142 and 146.

The waist belt 510 may be formed from a variety of inelastic materials such as, but not limited to, leather, ballistic nylon, etc. The pair of side bands 512, 514 are formed from an elastic materials having a predetermined rate of stretch and an assigned force value. In embodiments in which the pair of side bands 512, 514 are removably attached to the waist belt 510, the user 1000 may switch between sets of first side bands 512 and second side bands 514 having differing force values to provide differing degrees of downward pressure on the waist 1200 of the user 1000. In a further embodiment, the waist belt 510 is adjustable for different waist sizes by using a hook-and-loop fastener connection, and the clastic first side band 512 and the second side band 514 attach to loop members of the hook-and-loop fastener provided on the waist belt 510.

In operation, the bands 512 and 514 would be first connected to the attachment points 540; next, the user 1000 would approach the steps 130, bend down and pick up the upper ends 520 and 524 of the first and second side bands 512 and 514, respectively, and connect the upper ends 520 and 524 to the waist belt 510; subsequently, the user 1000 would climb the step assembly 130, and in doing so, would stretch the side bands 512, 514. The user 1000 would then shift from the first condition to the third condition, as heretofore described. As the user 1000 shifts forward in the harness 120 of the spinal decompression device 100, downward tension is applied by the pair of side bands 512, 514 onto the waist belt 510 to pull down on the waist 1200 of the user 1000. In the third condition, the waist belt 510 is vertically aligned with the second ends 522 and 526 of the side bands 512 and 514 such that the side bands 512 and 514 are arranged substantially vertically. In consequence, a downward tension is applied by the pair of side bands 512, 514 onto the waist belt 510 in the third condition, pulling down on the waist 1200 of the user 1000 and thereby further axially stretching the lumbar region 1100 of the user 1000. In this way, the side bands 512 and 514 produce a complementing “gravity assist” force during the third condition.

In some embodiments, the bands 512 and 514 may be available in different force levels, to suit individual needs. In further embodiments, the user 1000 may mount a weight-adjustable weight-belt around the waist, thereby increasing gravitation forces imparted on the lumbar region.

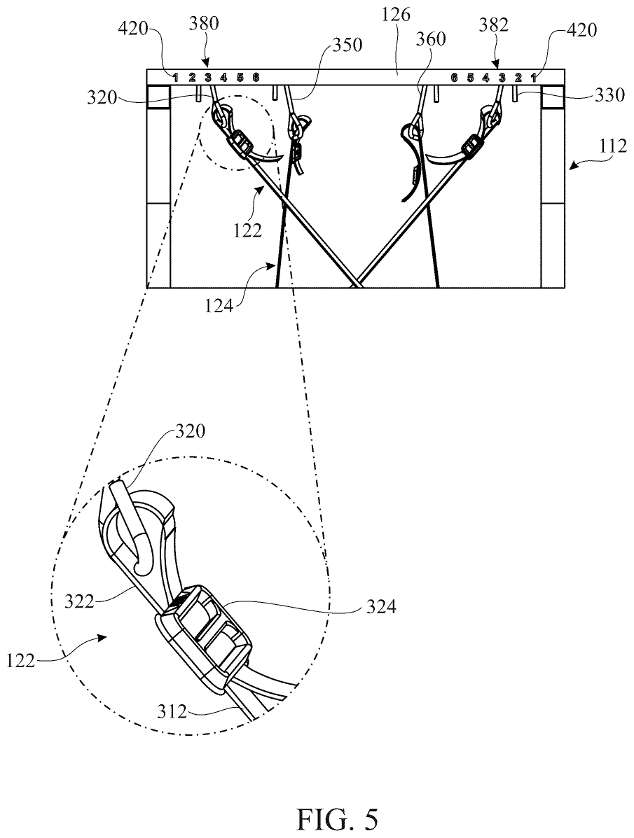

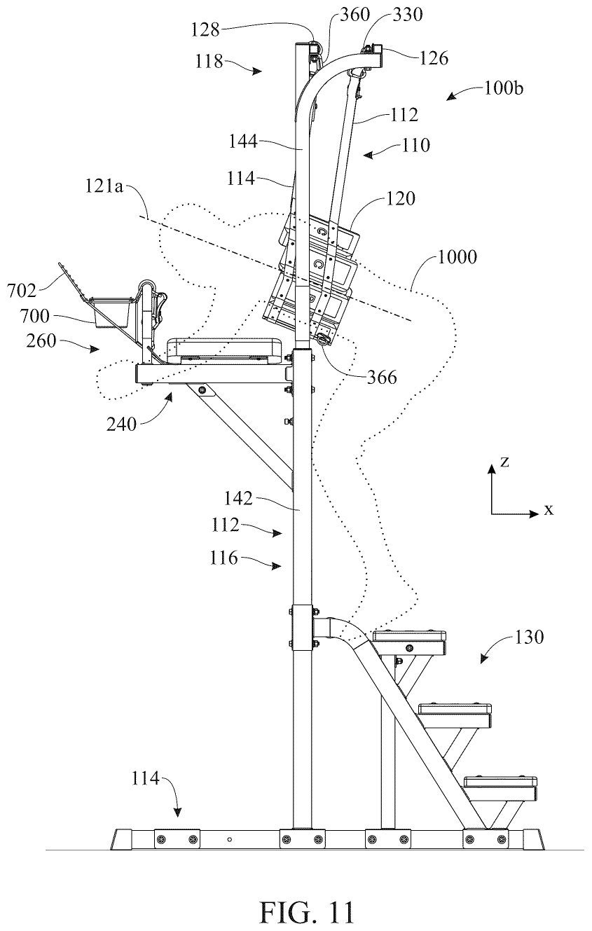

The illustrations of FIGS. 11-15 show a variation of the spinal decompression device 100 of FIGS. 1-9 in use by user 1000, this variation referred to hereinafter as spinal decompression device 100b. The spinal decompression device 100b of FIGS. 11-15 is constructed generally the same as the spinal decompression device 100 of FIGS. 1-9. The present spinal decompression device 100b includes additional elements such as, but not limited to, a cup holder 700 and an electronic device support 702 (e.g., panel or tray), which are carried by the frame 112 and preferably positioned at or near the front of the spinal decompression device 100b for purposes described hereinafter. For instance, the cup holder 700 and the electronic device support 702 shown herein are specifically attached to and carried by the bar assembly 266, 272 of the forward harness support assembly 260, adjacent to and frontward of the second ends 270, 294 of the bar assembly 266, 272 and thus positioned slightly frontward of the preferred gripping areas during operation of the device by a user.

In another example, the relative placement of the crossed strap 122 with respect to the harness 120 in the spinal decompression device 100b of FIGS. 11-15 is different to the relative placement of the crossed strap 122 with respect to the harness 120 of the spinal decompression device 100 of FIGS. 1-9. To better illustrate this difference, the flexible backing panel 300 (FIG. 2) of the harness 120 has been omitted from FIGS. 11-15.

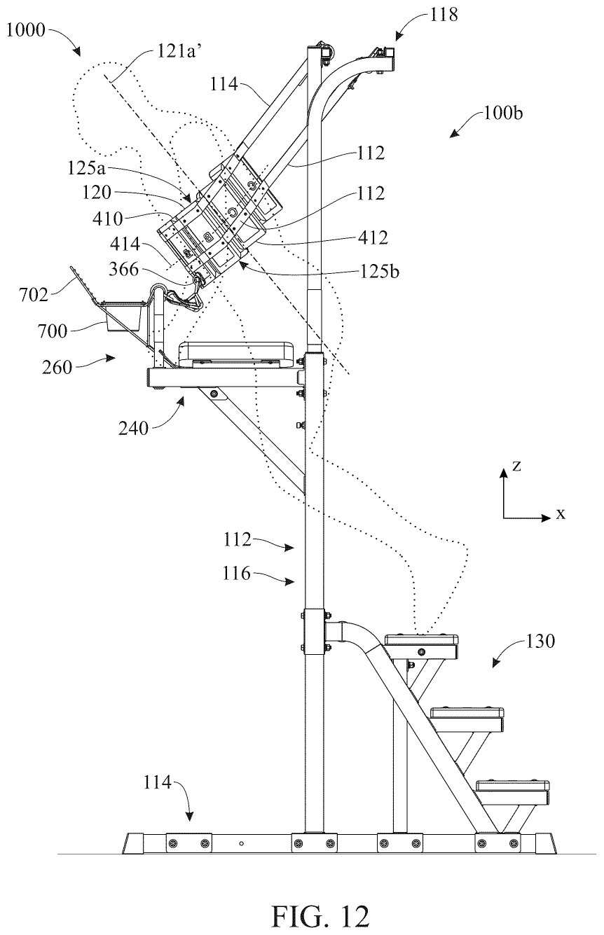

Specifically, turning to the spinal decompression device 100 and with reference to FIGS. 2 and 7, as shown, the second line of holes 372 formed in the harness 120, the corresponding fasteners 378 which connect the crossed strap 122 to the harness 120 at the second line of holes 372, and thus the crossed strap 122, extend along and adjacent to a rear edge 412 of the harness 120, i.e. are arranged closer to the rear edge 412 of the harness 120 than to a harness centerline 414 (FIG. 3) which is equidistant from the rear opening 125b (defined by the rear edge 412 of the harness 120) and the front opening 125a (defined by an opposite, front edge 410 of the harness 120). Additionally, the attachment devices 366 of the harness 120 are positioned at the crossed strap 122, i.e. at a same distance from the rear edge 412 than the crossed strap 122. In the spinal decompression device 100b, instead, as best shown in FIG. 12, the crossed strap 122 is arranged closer to the centerline 414 of the harness 120 than to the rear edge 412 of the harness 120, while the attachment devices 366 of the harness 120 are arranged relatively closer to the rear edge 412 of the harness 120 as in the previous embodiment.

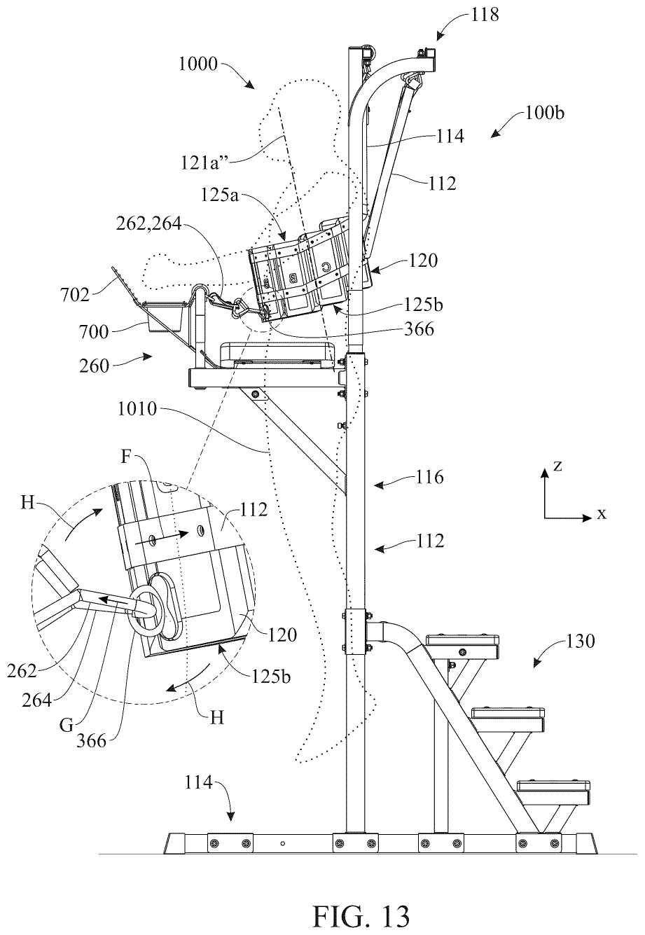

The spinal decompression device 100b of FIGS. 11-15 is operated following the same steps as heretofore described with reference to the spinal decompression device 100 of FIG. 1-9. Therefore, unless expressly indicated otherwise, the method of operation of the spinal decompression device 100 of FIGS. 1-9 is the same as the method of operation of the spinal decompression device 100b of FIGS. 11-15. Turning to FIG. 11, as with the previous embodiment, the user 1000 begins by climbing the step assembly 130 and extending his or her body 1010 forward through the harness 120 and the frame 112, reaching the first condition. Next, the user 1000 loads their body weight onto the harness 120, uses their legs to push forward on the harness 120, and secures the harness 120 by fastening the first and second lower straps 262 and 266 (via hooks 280 and 290) to the attachment devices 366 as heretofore described, positioning the harness 120 in the second condition. Turning to FIG. 13, the user 1000 may then step off the step assembly 130 and become comfortably suspended from the harness 120 with the user's body 1010 arranged substantially vertical and subjected to an axial traction. As with the previous embodiment, as the harness 120 shifts through the first, second and third conditions, the harness 120 is increasingly more vertically arranged, as is the central axis of the harness (denoted with reference numerals 121a, 121a′, and 121a″ in FIGS. 11, 12 and 13, respectively). Furthermore, as can be seen in FIG. 12, because the crossed strap 122 is closer to the harness centerline 141 than the attachment devices 366 (to which the lower straps 262, 264 are connected), a generally rearward force (arrow F) exerted by the crossed strap 122 on the harness 120 is vertically offset relative to a generally frontward force (arrow G) exerted by the lower front straps 262, 264 on the harness 120; said forces E, F create a torque on the harness 120 which assists in rotating the harness 120 rearward and downward (clockwise in the figure), as indicated by arrows H, towards an even more horizontal orientation (i.e. towards a vertical orientation of the central axis 121a″). Additionally, the crossed strap 122 exerting the inwardly radial load force closer to the centerline 414 of the cushions 302 causes the applied forces over each cushion's vertical length to be more evenly distributed vertically above and below the crossed strap 122 in the third condition, and thus across the contact surface area (contact surfaces 304) of the cushion 302, further enhancing comfort. In a further advantageous effect, the crossed strap 122 exerting said radial force close to the centerline 144 results in a further equalized friction across the cushion contact surface, which may result in a net-lower required inwardly radial force by the crossed strap 122.

With continued reference to FIG. 13, once the user 1000 has achieved the suspended position, the user 1000 may let go of the forward harness support assembly 260 and remain comfortably suspended hands-free, or otherwise use his or her hands 1040 to carry out a different task, such as viewing their phone or tablet. In some embodiments, while upright and decompressing in the traction device, the user 1000 may support their phone or tablet on the electronic device support 702, which is ergonomically positioned for convenient viewing and handling. The invention may thus advantageously integrate personal device use into spine-stretching therapy, which may enhance user satisfaction and improve session adherence.

The spinal decompression device 100/100b disclosed herein allows for a variety of adjustments which facilitate installing, uninstalling, transporting and/or storing the spinal decompression device 100/100b, and/or may enable user customization of the spinal decompression device 100/100b and the physical treatment thereby provided. In a first adjustment example, referring for instance to FIGS. 1 and 11, the frame 112 may be height-adjusted by sliding the first and second upper channels 144 and 148 into and out of the first and second lower channels 142 and 146, respectively, allowing to adjust the height of the top support assembly 118, and more specifically, the elevation of the rear and front crossbars 126 and 128 from which the harness 120 is suspended.

In a second adjustment example of the spinal decompression device 100/100b, and with reference for instance to FIGS. 1, 2 and 5, the hooks 360 and 350 of the U-shaped strap 124 may be selectively engaged with any one of the first and second sets of adjustment holes 390 and 392, respectively, of the front crossbar 128 of the frame 112. This allows to adjust the relative position between the first and second strap segments 342 and 344 of the U-shaped strap 124, depending on the size of the user, which is particularly relevant in the starting position—or first condition—of the harness 120. The adjustment holes 390, 392 of the front crossbar 128 may include visible markings 422 (e.g., numbers ranging from “1” to “6”) configured to guide the user in selecting the specific adjustment holes 390, 392 to be used.

In another adjustment example of the spinal decompression device 100/100b, and with reference to FIGS. 1 and 4, the hooks 330 and 320 of the crossed strap 122 may be selectively engaged with any one of the first and second sets of adjustment holes 380 and 382, respectively, in the rear crossbar 126 of the frame 112. This allows to vary the distance between the hooks 330 and 320—and thus the diameter of the harness 120 as heretofore described—and thereby adjust the radial “snugness” of the harness 120 about the user's upper-abdominal and lower thoracic region 1030 during operation of the spinal decompression device 100/100b, balancing the vertical holding power of shear-friction with the desired comfort level (ability for the user 1000 to breathe normally by means of the dilation and contraction of the harness 120, including the top opening 125c). The adjustment holes 380, 382 of the rear crossbar 126 may include visible markings 420 (e.g., letters ranging from “A” to “E”) configured to guide the user in selecting the specific adjustment holes 380, 382 to be used. For example, by positioning the hooks 330 and 320 in relatively outer holes, such as holes numbered “3”, the hooks 330 and 320 are positioned further apart on the rear crossbar 126 to increase the horizontal pulling of the crossed strap 122 in the third condition (heretofore discussed with reference to FIG. 8) and thus increase the radial fitting provided by the harness 120 on a torso of a user. Conversely, positioning the hooks 330 and 320 more inwardly, such as attached to adjustment holes 380 and 382 numbered “1” or “2”, reduces said horizontal pulling and thereby decreases the radial “snugness” on the upper-abdominal and lower thoracic region of the user.

The radial “snugness” of the harness 120 about the user's upper-abdominal and lower thoracic region 1030 may be further customized by adjusting the rear buckles 324, 334 of the crossed strap 122 to vary the length of the first and second strap segments 312 and 314 of the crossed strap 122. This adjustment may also help to adjust the traction assembly 110 to different user body sizes.

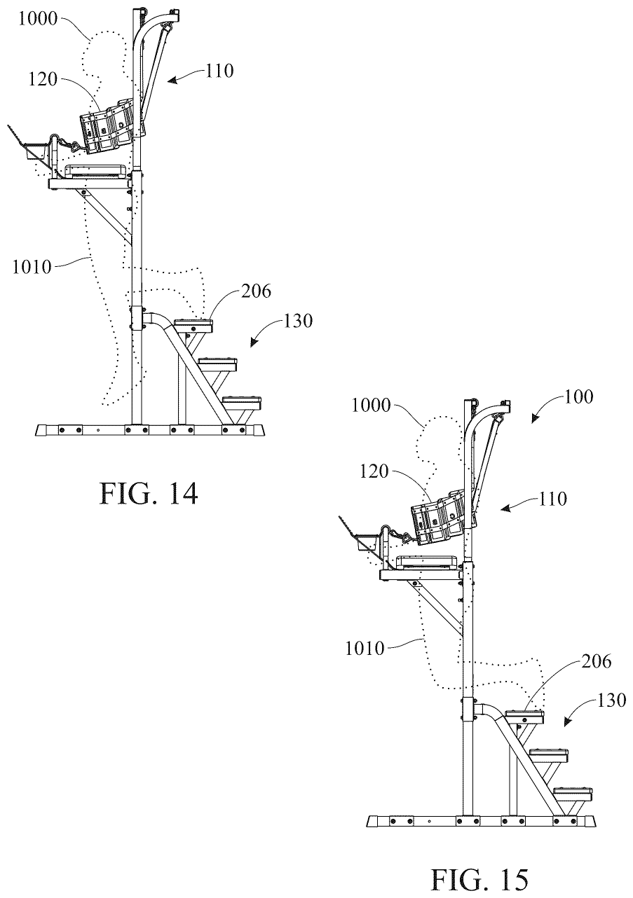

In a further adjustment example, the spinal decompression device 100/100b allows the user 1000 to self-adjust the traction force during decompression. The user 1000 can modulate lumbar traction by shifting the weight of one foot or both feet on the step assembly 130 without said foot or feet stepping off the step assembly 130. This allows to achieve three discrete gravity-based traction levels in an upright suspended posture. For example, in the third condition shown in FIGS. 9 and 13, the user 1000 has stepped both feet off the step assembly 130 and is fully suspended from the traction assembly 110 and being subjected to a downward traction force by gravity as heretofore described. In an alternative third condition shown in FIG. 14, the user 1000 has stepped one foot off the step assembly 130 and shifted the weight of the other foot on the step assembly 130, thereby subtracting the approximate weight of one lower leg from the total traction force and thus achieving a lower traction force with respect to the third condition of FIGS. 9 and 13. Finally, in a further alternative third condition shown in FIG. 15, the user 1000 has shifted the weight of both feet on the step assembly 130 and kneeled forward to suspend his or her weight on the traction system 110 thereby subtracting the approximate weight equivalent to both lower legs with a resulting, relatively lower traction force with respect to the third condition of FIG. 14. In this way, the user him or herself has control over three different, discrete levels of traction of the lumbar compression device 100, and can thereby perform his or her own self-paced ramp-up towards progressively higher lumbar traction levels. This adjustment between the three discrete levels of traction of FIGS. 13, 14, and 15 may be carried out by the user 1000 while in the third condition, i.e. while hands-free and while comfortably and continuously decompressing.

In yet another adjustment example, the spinal decompression device 100/100b allows to adjust the flexion angle. By adjusting the slider-buckles 286 and 296 at the front lower straps 262 and 264, respectively, and the adjustment buckles 324 and 334 at the crossed strap 122, the user can fine-tune the offset-from-vertical angle (i.e., the angle between the central axis 121a″ in the third condition and vertical direction z) in order for the user 1000 to be either in slight flexion (cat stretch), vertically neutral, or in various degrees in between.

Alternative embodiments are contemplated without departing from the scope of the present disclosure. For example, a rear strap can be designed in a U-shaped configuration and the mechanical radially inward force achieved by placing rollers or pulleys between left and right extensions of the rear strap and pulling both extensions together to form an X-configuration. Still further, a front strap could be formed as an X-shaped strap similar to the crossed strap 122 described hereinabove.

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalents.

What is claimed is:

1. A spinal decompression system comprising:
a traction assembly, comprising:
a harness defining a harness space configured to receive a portion of a body of a user therethrough, the harness flexibly conformable and securable to said portion of said body by a cinching of said harness against said portion of said body, wherein the harness is open-ended such that the harness only partially encircles said portion of said body, and
a suspended, strap assembly, attached to and carrying the harness in an elevated relationship with a ground arranged below the harness, said elevated relationship enabling the user to be suspended from the harness, the strap assembly comprising one or more flexible, crossed straps, wherein each crossed strap of the one or more crossed straps comprises respective first and second strap segments having respective first ends attached to said opposite sides of the harness, the respective first and second strap segments extending from said opposite sides of the harness in respective oblique orientations towards one another and in a crossed and disconnected relationship with one another, wherein
the harness is cinchable onto said portion of the body responsively to said respective first ends of said respecting first and second strap segments of said each cross strap exerting respective oblique forces on said opposite sides of the harness as a result of at least part of a weight of the body of the user being loaded on the harness, said respective oblique forces oriented towards each other.

2. The spinal decompression system of claim 1, wherein the harness is C-shaped.

3. The spinal decompression system of claim 1, wherein the harness is cushioned.

4. The spinal decompression system of claim 3, wherein the harness comprises a plurality of cushions arranged in consecutive and pivotable relationship with one another forming an articulated body configured to conform to the user's body.

5. The spinal decompression system of claim 4, wherein the harness comprises a flexible backing panel, wherein the plurality of cushions are attached to and carried by the flexible backing panel.

6. The spinal decompression system of claim 5, wherein each cushion of the plurality of cushions comprises a respective contact surface configured to abut against the user's body, the contact surfaces of the plurality of cushions arranged in continuation of one another.

7. The spinal decompression device of claim 1, wherein said each crossed strap of the one or more crossed straps further comprises a respective center strap segment extending along the harness and interconnecting the respective first and second segments of said each crossed strap.

8. The spinal decompression system of claim 7, wherein the harness comprises a flexible backing panel and a plurality of cushions attached to and carried by the flexible backing panel, and further wherein said respective center strap segment is positioned between the flexible backing panel and the plurality of cushions of the harness.

9. The spinal decompression system of claim 1, wherein the strap assembly is suspended from a structure, and further wherein the respective first and second strap segments of said each crossed strap are secured to the structure at adjustable points of said structure thereby allowing to adjust said respective oblique orientations of the respective first and second strap segments.

10. The spinal decompression system of claim 1, wherein the respective first and second strap segments of said each crossed strap are length-adjustable.

11. The spinal decompression system of claim 1, wherein the one or more crossed straps comprise a rear crossed strap arranged closer to a rear edge of the harness than to a front edge of the harness, the front and rear edges of the harness arranged opposite one another along an axial direction of the harness space.

12. The spinal decompression system of claim 11, wherein the strap assembly further comprises a U-shaped strap arranged frontward of the rear crossed strap, the U-shaped strap comprising first and second strap segments attached to and extending from said opposite sides of the harness in a non-crossed relationship with one another.

13. The spinal decompression system of claim 12, wherein the strap assembly is suspended from a structure, and further wherein the first and second strap segments of the U-shaped strap are secured to the structure at adjustable points of the structure thereby allowing to adjust a separation between the first and second strap segments of the U-shaped strap.

14. The spinal decompression system of claim 12, wherein the first and second strap segments of the U-shaped strap are length-adjustable.

15. The spinal decompression system of claim 1, wherein the traction assembly is movable from a suspended and unweighted, first condition to a second condition in which the harness is shifted forward with respect to the first condition and secured to a structure, wherein an axial direction of the harness space has a greater vertical component in the second condition than in the first condition.

16. The spinal decompression system of claim 15, wherein the harness is adjustably securable to the structure in the second condition to vary a distance between the harness and the structure in the second condition.

17. The spinal decompression system of claim 15, wherein the traction assembly is further movable from the second condition to a third condition as a result of said at least part of the weight of the body of the user being loaded on the harness, wherein the harness in the third condition remains secured to the structure and is pivoted downward and rearward relative to the second condition such that the axial direction of the harness space has a greater vertical component in the third condition than in the second condition.

18. The spinal decompression device of claim 17, wherein, in the second and third conditions, the structure is releasably secured to an attachment device of the harness, and further wherein, in the third condition of the harness, the attachment device is arranged lower than the respective first ends of said each crossed strap of the one or more crossed straps thereby generating a torque contributing to vertically position the axial direction of the harness space.

19. The spinal decompression device of claim 1, wherein the harness is configured to maintain a substantially constant normal force against said portion of the body of the user during expansion and contraction of said portion of the body as a result of breathing.

20. The spinal decompression device of claim 1, further comprising a step arranged in an elevated position with respect to the ground and vertically lower than the harness, wherein the step is configured to allow the user to switch from a first position in which the user is standing on said step to a second position in which the said portion of the user's body is extended into the harness and at least part of the user's weight is loaded on the harness.

21. The spinal decompression device of claim 20, wherein the step is configured to allow the user to switch from the first position to the second position while stepping off the harness with one foot of said user and maintaining the other foot on said step.

22. The spinal decompression device of claim 20, wherein the step is configured to allow the user to switch from the first position to the second position while maintaining the both feet on said step.

23. The spinal decompression device of claim 20, wherein the step is configured to allow the user to switch from the first position to the second position while stepping both feet of said step.

24. A spinal decompression system comprising:
a standalone frame configured to stably rest on a ground, the frame comprising a built-in step assembly configured for a user to climb thereon to acquire potential energy; and
a traction assembly, comprising:
a harness, defining a harness space accessible by the user climbing the step assembly and configured to receive a portion of a body of the user therethrough, the harness flexibly conformable and securable to said portion of said body by a cinching of said harness against said portion of said body, wherein the harness is open-ended such that the harness only partially encircles said portion of said body, and
a strap assembly, suspended from the frame, the strap assembly attached to and carrying the harness in an elevated relationship with a ground arranged below the harness, said elevated relationship enabling the user to be suspended from the harness, the strap assembly comprising one or more flexible, crossed straps, wherein each crossed strap of the one or more crossed straps comprises respective first and second strap segments having respective first ends attached to said opposite sides of the harness, the respective first and second strap segments extending from said opposite sides of the harness in respective oblique orientations towards one another and in a crossed and disconnected relationship with one another, wherein
the harness is cinchable onto said portion of the body responsively to said respective first ends of said respecting first and second strap segments of said each cross strap exerting respective oblique forces on said opposite sides of the harness as a result of at least part of a weight of the body of the user being loaded on the harness, said respective oblique forces oriented towards each other.

25. A method of applying spinal decompression, comprising:
engaging a lower thoracic and upper abdominal region of a body of a user with a harness that only partially encircles said region;
suspending the harness to support the user in a substantially vertical orientation; and
maintaining a substantially constant normal force on said region of the body by the harness while the harness increases and decreases in diameter in coordination with user respiration.
